(19) United States
(12) Patent Application Publication
(10) Pub. No.: US 2024/0182262 A1
(43) Pub. Date: Jun. 6, 2024

(54) SIGNAL PROCESSING APPARATUS, METHOD, AND ELEVATOR MONITORING APPARATUS

(71) Applicant: KABUSHIKI KAISHA TOSHIBA, Tokyo (JP)

(72) Inventor: Takashi SUDO, Fuchu Tokyo (JP)

(73) Assignee: KABUSHIKI KAISHA TOSHIBA, Tokyo (JP)

(21) Appl. No.: 18/458,901

(22) Filed: Aug. 30, 2023

(30) Foreign Application Priority Data
Dec. 6, 2022 (JP) 2022-194983

(51) Int. Cl. B66B 5/00; H04R 1/02

(52) U.S. Cl. CPC B66B 5/0018; H04R 1/028

(57) ABSTRACT

According to one embodiment, a signal processing apparatus comprising processing circuitry. The processing circuitry is configured to acquire an environmental sound in an environment where an operating sound of an observation target can be collected. The processing circuitry is configured to calculate colorability and variation in frequency spectrum intensity concerning the environmental sound. The processing circuitry is configured to determine whether or not the environmental sound includes the operating sound by comparing the colorability and a degree of the variation with thresholds.

### CROSS-REFERENCE TO RELATED APPLICATIONS

This application is based upon and claims the benefit of priority from Japanese Patent Application No. 2022-194983, filed Dec. 6, 2022, the entire contents of which are incorporated herein by reference.

### FIELD

Embodiments described herein relate generally to a signal processing apparatus, method, and an elevator monitoring apparatus.

### BACKGROUND

There have been proposed various techniques of detecting an anomaly in equipment from an environmental sound including the operating sound of the equipment. It is difficult to extract a desired machine sound from environmental sounds acquired in an environment where there are similar machine sounds. A technique is available which extracts a desired machine sound based on the periodicity of the operating sound of a motor or the stationarity of the spectrum shape of the operating sound. However, this technique cannot be used for the purpose of detecting a machine sound without any periodicity as a desired sound. In addition, the technique which detects the stationarity of a spectrum erroneously detects stationary noise or noise with a specific frequency.

There is also available a technique of automatically extracting a representation by using a trained model such as a deep neural network. However, using a trained model will require a large processing amount and hence will require a calculation resource.

### BRIEF DESCRIPTION OF THE DRAWINGS

FIG. 1 is a block diagram showing a signal processing apparatus according to the first embodiment.

FIG. 2 is a view showing an example of calculating colorability and variation in frequency spectrum intensity.

FIG. 3A is a graph showing the first example of determination processing by a determination unit.

FIG. 3B is a graph showing the first example of determination processing by the determination unit.

FIG. 4A is a graph showing the second example of determination processing by the determination unit.

FIG. 4B is a graph showing the second example of determination processing by the determination unit.

FIG. 5 is a block diagram showing the first modification of the signal processing apparatus according to the first embodiment.

FIG. 6 is a flowchart showing the operation of the signal processing apparatus according to the first embodiment.

FIG. 7 is a flowchart showing another example of operating sound determination processing in the signal processing apparatus.

FIG. 8 is a block diagram showing the second modification of the signal processing apparatus according to the first embodiment.

FIG. 9 is a block diagram showing the third modification of the signal processing apparatus according to the first embodiment.

FIG. 10 is a block diagram showing the fourth modification of the signal processing apparatus according to the first embodiment.

FIG. 11 is a block diagram showing the fifth modification of the signal processing apparatus according to the first embodiment.

FIG. 12 is a block diagram showing a signal processing system according to the second embodiment.

FIG. 13 is a conceptual view of an elevator monitoring apparatus including a signal processing apparatus according to the third embodiment.

FIG. 14 is a block diagram showing an example of the hardware arrangement of the signal processing apparatus according to the embodiment.

### DETAILED DESCRIPTION

In general, according to one embodiment, a signal processing apparatus comprising processing circuitry. The processing circuitry is configured to acquire an environmental sound in an environment where an operating sound of an observation target can be collected. The processing circuitry is configured to calculate colorability and variation in frequency spectrum intensity concerning the environmental sound. The processing circuitry is configured to determine whether or not the environmental sound includes the operating sound by comparing the colorability and a degree of the variation with thresholds.

A signal processing apparatus and method, a program, and an elevator monitoring apparatus according to this embodiment will be described in detail below with reference to the accompanying drawings. Note that components denoted by the same reference numerals perform similar operations in the following embodiments, and a repetitive description will be omitted as appropriate.

### First Embodiment

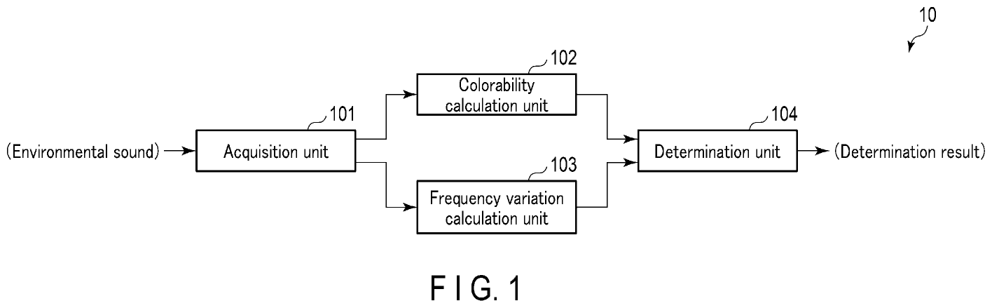

A signal processing apparatus according to the first embodiment will be described with reference to the block diagram of FIG. 1.

A signal processing apparatus 10 according to the first embodiment includes an acquisition unit 101, a colorability calculation unit 102, a frequency variation calculation unit 103, and a determination unit 104. Note that a combination of the colorability calculation unit 102 and the frequency variation calculation unit 103 will also be simply referred to as a calculation unit.

The acquisition unit 101 acquires an environmental sound collected in an environment where the operating sound of an observation target can be collected. The acquisition unit 101 may externally acquire the data of the environmental sound. Alternatively, a microphone may be connected as the acquisition unit 101 to the signal processing apparatus 10 to directly acquire an environmental sound from the microphone.

The colorability calculation unit 102 receives an environmental sound from the acquisition unit 101 and calculates colorability concerning the environmental sound. Colorability indicates a biased state in which the intensity of a spectrum is not constant (flat) or the degree of bias when the frequency spectrum of a sound is generated. In this case, colorability is represented by the periodicity intensity of a signal with a single frequency or a plurality of frequencies. For example, colorability is observed if the spectrum intensity of a specific frequency like a human voice or its harmonic is high. That is, the voice is a colored signal.

The frequency variation calculation unit 103 receives an environmental sound from the acquisition unit 101 and calculates variation in the intensity of the frequency spectrum (to be also referred to as the frequency spectrum intensity) of the environmental sound, that is, the variance of the frequency spectrum intensity in the frequency direction. Note that a standard deviation may be calculated instead of a variance. A frequency spectrum intensity is, for example, a power spectrum, energy spectrum, or power spectrum density.

Note that the colorability calculation unit 102 and the frequency variation calculation unit 103 each may execute calculation processing upon downsampling an acquired environmental sound from, for example, 48 kHz to 8 kHz to reduce the processing amount. Alternatively, after the acquisition unit 101 downsamples an environmental sound, the colorability calculation unit 102 and the frequency variation calculation unit 103 on the subsequent stages may output the environmental sound after the downsampling.

The determination unit 104 receives colorability from the colorability calculation unit 102 and a calculated variation degree from the frequency variation calculation unit 103. The determination unit 104 compares the colorability and the variation degree with thresholds to determine whether the environmental sound includes the operating sound of the observation target and generates a determination result. More specifically, if the environmental sound has colorability and small variation, the determination unit 104 determines that the environmental sound includes the operating sound of the observation target.

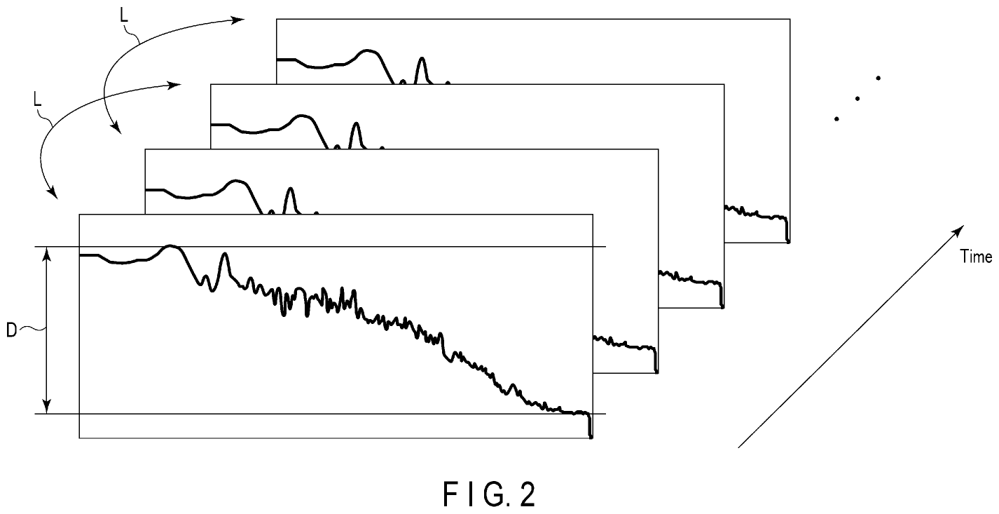

An example of calculating colorability and variation in frequency spectrum intensity will be described next with reference to FIG. 2.

FIG. 2 shows an example of the frequency spectrum of sampling data concerning an environmental sound and an example of sampling data arranged along the time series. A frequency spectrum may be generated by, for example, performing FFT (Fast Fourier Transform) processing of the sampling data of an environmental sound.

Colorability is calculated as the intensity of periodicity by calculating a kth-order autocorrelation coefficient (k takes an integer equal to or more than 1 and becomes a nonzeroth-order autocorrelation coefficient). Note that a kth order represents a lag number L indicating a specific number of samples by which an autocorrelation coefficient is shifted at the time of performing autocorrelation processing of the sampling data of an environmental sound. That is, an kth order indicates a specific sampling data interval in which an autocorrelation coefficient is to be calculated. If k=1, it indicates the interval between adjacent sampling data. If k=2, it indicates the interval between every two sampling data. If k=3, it indicates the interval between every three sampling data. In the example shown in FIG. 2, an autocorrelation coefficient is calculated with k=3, that is, between every three sampling data. The presence of colorability is visually determined if the spectrum intensity of the sampling data shown in FIG. 2 has peaks at a plurality of frequencies and is not flat when viewed from the frequency axis. Note that a partial autocorrelation coefficient may be calculated instead of a kth-order autocorrelation coefficient. Colorability may be evaluated based on the fluctuation of a plurality of autocorrelation coefficients in its time direction which are calculated while the autocorrelation coefficient calculated in a predetermined time width (frame) is shifted by a given time width (shift length). Although it depends on an observation target, since the colorability of human voice is sometimes large with a small value of k such as K=1, it is preferable to use a slightly large value of k such as k=3.

On the other hand, variation in frequency spectrum intensity is calculated by calculating the variance of the frequency spectrum intensity. Variation can be visually determined from a distribution D of the maximum and minimum peaks of the frequency spectrum intensity of the sampling data shown in FIG. 2. Note that variation in frequency spectrum intensity may be calculated based on the center of gravity of the frequency spectrum intensity. Alternatively, the center of gravity of spectrum intensity may be calculated in a predetermined frequency range. Calculating the center of gravity of spectrum intensity can express the bias of the distribution of spectrum intensity. Alternatively, variation in frequency spectrum intensity or its center of gravity may be calculated by using a logarithmic power spectrum.

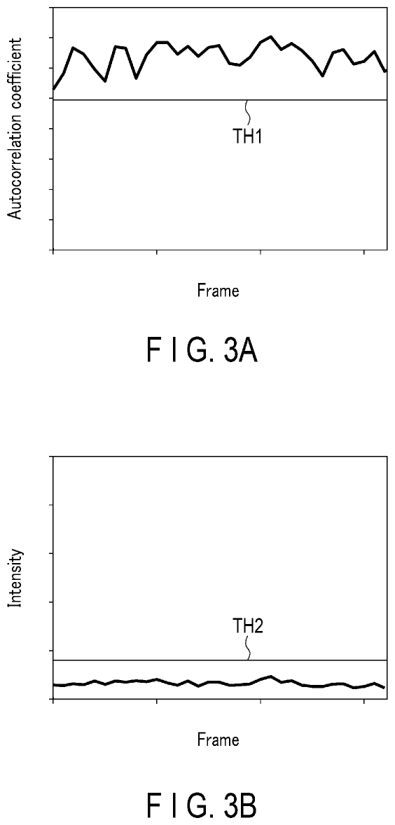

The first example of determination processing by the determination unit 104 will be described next with reference to FIGS. 3A and 3B.

FIG. 3A shows the third-order autocorrelation coefficient of sampling data for each frame when the sampling data with the predetermined time width shown in FIG. 2 is regarded as one frame. The ordinate represents the autocorrelation coefficient, and the abscissa represents the frame index in the time direction. The determination unit 104 uses an autocorrelation coefficient as a colorability degree. Referring to FIG. 3A, most of the values of the autocorrelation coefficients of the respective frames exceed a threshold TH1.

FIG. 3B shows an example of calculating variation in the frequency spectrum intensity of the same sampling data as that shown in FIG. 3A in the form of the variance of the logarithmic power spectrum dB-converted for each frame. The ordinate represents the variance value, and the abscissa represents the frame index in the time direction. The determination unit 104 uses the variance of a logarithmic power spectrum as a variation degree. Referring to FIG. 3B, the variance value for each frame is equal to or less than a threshold TH2.

The determination unit 104 counts the number of frames in which the autocorrelation coefficients are equal to or more than the threshold TH1 and the variance values are equal to or less than the threshold TH2 and determines, based on the results shown in FIGS. 3A and 3B, that the environmental sound includes the operating sound of the observation target if the ratio of the number of counted frames to the total number of frames is equal to or more than a predetermined value. In other words, the determination unit 104 determines that the environmental sound includes the operating sound of the observation target if the environmental sound has colorability and the variation in frequency spectrum intensity is small.

Note that the reason why the ratio to the total number of frames is used for the above determination is that the analysis time width for the determination is set to a time width longer than a frame. Accordingly, the determination unit 104 obtains results on a plurality of frames and integrates the results on the plurality of frames, thereby obtaining a final determination result.

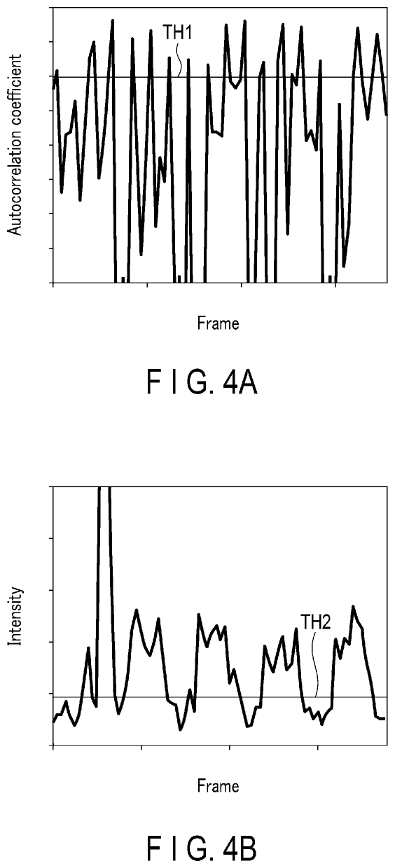

The second example of determination processing by the determination unit 104 will be described next with reference to FIGS. 4A and 4B.

FIGS. 4A and 4B are graphs respectively showing the same autocorrelation coefficient and the same variance of frequency spectrum intensity as those shown in FIGS. 3A and 3B except that the sampling data are different from each other.

Referring to FIG. 4A, most of the autocorrelation coefficients of the respective frames are less than the threshold TH1. Accordingly, the determination unit 104 can determine that the environmental sound represented by the sampling data shown in FIG. 4A has no colorability.

In contrast to this, referring to FIG. 4B, many of the variance values of the respective frames are larger than the threshold TH2. Accordingly, the determination unit 104 can determine that the environmental sound represented by the sampling data shown in FIG. 4B has a large frequency variation.

Based on the results shown in FIGS. 4A and 4B, since the environmental sound has no colorability and the frequency variance is large, the determination unit 104 can determine that the environmental sound does not include the operating sound of the observation target. Note that if at least one of the conditions, i.e., having colorability and that the frequency variation is small, is not satisfied, the determination unit 104 may determine that the environmental sound does not include the operating sound of the observation target.

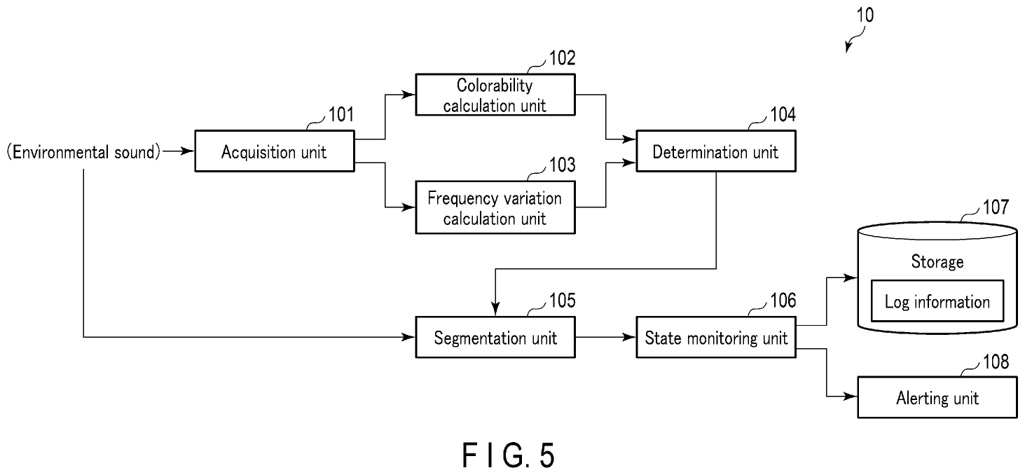

The first modification of the signal processing apparatus 10 according to the first embodiment will be described next with reference to the block diagram of FIG. 5.

The signal processing apparatus 10 according to the first modification includes the acquisition unit 101, the colorability calculation unit 102, the frequency variation calculation unit 103, the determination unit 104, a segmentation unit 105, a state monitoring unit 106, a storage 107, and an alerting unit 108.

The segmentation unit 105 receives an environmental sound from outside and a determination result from the determination unit 104. The segmentation unit 105 segments a partial environmental sound which is a partial section of the environmental sound determined by the determination unit 104 to include the operating sound of the observation target. Note that if an environmental sound is collected by microphones corresponding to a plurality of channels having established temporal synchronization, the environmental sound collected by a microphone for a given channel may be used for determination, and the environmental sound collected by a microphone for another channel may be used for segmentation and state monitoring.

The state monitoring unit 106 receives a partial environmental sound from the segmentation unit 105, monitors the state of an observation target based on the partial environmental sound, calculates an anomaly score as an anomaly degree, determines that the observation target is normal if the anomaly score is less than a predetermined threshold or that the observation target is anomaly if the anomaly score is equal to or higher than the threshold, and generates status information including a determination result indicating whether the observation target is normal or anomaly and the time when it is determined that the observation target is anomaly. For example, the state monitoring unit 106 determines the state of the observation target by using a trained model. For example, the state monitoring unit 106 determines the state of the observation target by using a deep neural network such as an auto-encoder as disclosed in Jpn. Pat. Appln. KOKAI Publication No. 2021-33842.

The storage 107 receives a partial environmental sound and status information (the time, anomaly score, and determination result about normal/anomaly) from the state monitoring unit 106 and stores them as log information.

The alerting unit 108 receives status information from the state monitoring unit 106 and issues an alert or the like to the outside.

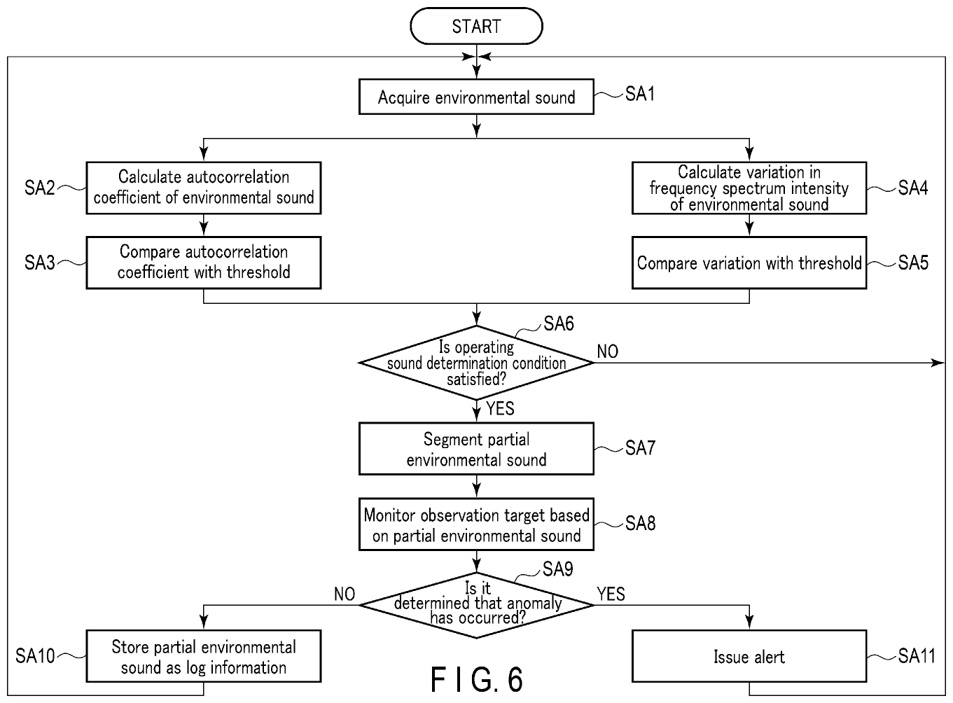

The operation of the first modification of the signal processing apparatus 10 shown in FIG. 5 will be described next with reference to the flowchart of FIG. 6.

In step SA1, the acquisition unit 101 acquires the sampling data of an environmental sound.

In step SA2, the colorability calculation unit 102 calculates the autocorrelation coefficient of the environmental sound by, for example, the technique described with reference to FIG. 2.

In step SA3, the determination unit 104 compares the autocorrelation coefficient with the threshold (TH1).

In step SA4, the frequency variation calculation unit 103 calculates variation in the frequency spectrum intensity of the environmental sound by using, for example, the technique described with reference to FIG. 2.

In step SA5, the determination unit 104 compares the variation in the frequency spectrum intensity with the threshold (TH2). Note that the determination unit 104 may set two thresholds and determine whether the value of the variation falls within the range of the two thresholds. This makes it possible to determine whether the environmental sound includes an operating sound with a specific frequency.

In step SA6, the determination unit 104 determines whether an operating sound determination condition is satisfied. More specifically, the determination unit 104 determines whether the environmental sound has colorability and the variation in the frequency spectrum intensity is small. If the environmental sound has colorability and the variation in the frequency spectrum intensity is small, the determination unit 104 determines that the environmental sound includes the operating sound of the observation target, and the process advances to step SA7. If the environmental sound has no colorability or the variation in the frequency spectrum intensity is large, the determination unit 104 determines that the environmental sound does not include the operating sound of the observation target, and the process returns to step SA1 to repeat similar processing.

In step SA7, the segmentation unit 105 segments a partial environmental sound.

In step SA8, the state monitoring unit 106 monitors the observation target based on the partial environmental sound.

In step SA9, the state monitoring unit 106 determines whether an anomaly has occurred in the observation target. If, for example, a trained model used by the state monitoring unit 106 is an auto-encoder, the state monitoring unit 106 inputs the partial environmental sound to the trained model. If the difference between an output from the trained model and the input partial environmental sound is equal to or more than a threshold, the state monitoring unit 106 can determine that the observation target is anomaly. If an anomaly has occurred in the observation target, the process advances to step SA11. If no anomaly has occurred in the observation target, the process advances to step SA10.

In step SA10, the storage 107 associates the partial environmental sound with status information indicating whether an anomaly has occurred in the partial environmental sound and stores the resultant information as log information. Thereafter, the process returns to step SA1 to repeat similar processing.

In step SA11, the alerting unit 108 issues, to the outside, an alert informing the occurrence of an anomaly in the observation target. The alerting means may output, for example, an alert sound, output information concerning the anomaly in a synthetic voice from a loudspeaker, or display information concerning the anomaly on a monitoring display. Note that in addition to the processing in step SA11, the status information and the partial environmental sound corresponding to the occurrence of the anomaly may be stored as log information in the storage 107.

Note that the execution order of processing from step SA2 to step SA5 is not limited to that described above, and step SA2 and step SA4 may be concurrently executed or the processing in step SA3 and step SA5 may be concurrently executed by the determination unit 104.

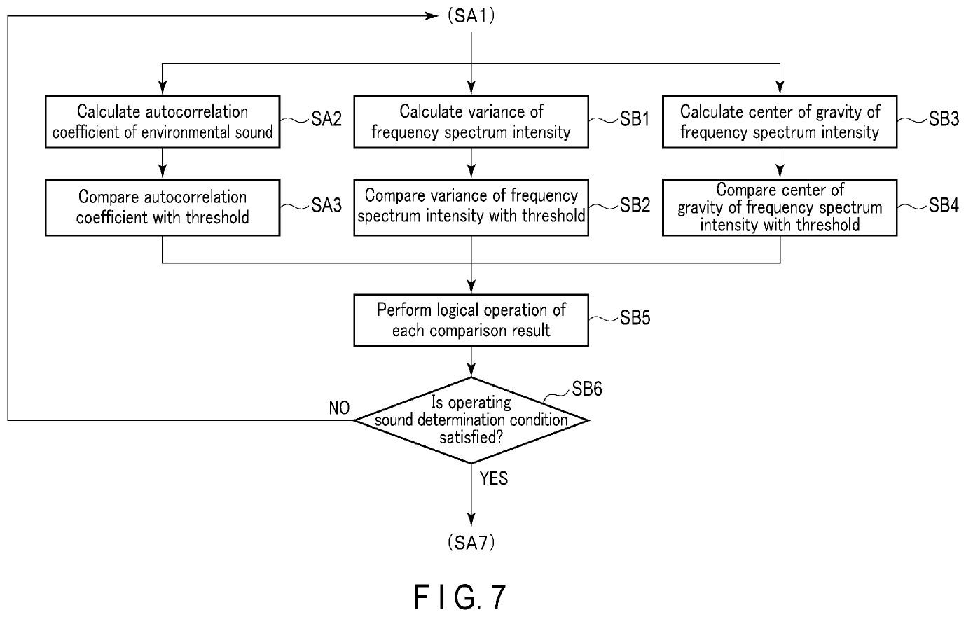

Another example of operating sound determination processing in the signal processing apparatus 10 will be described next with reference to the flowchart of FIG. 7.

The calculation of colorability in steps SA2 and SA3 is similar to the processing in FIG. 6, and hence a description of the processing will be omitted. In step SA3, the autocorrelation coefficient is compared with the threshold TH1. If the autocorrelation coefficient is equal to or more than the threshold TH1, 1 may be output as a comparison result. If the autocorrelation coefficient is less than the threshold TH1, 0 may be output as a comparison result.

In step SB1, the frequency variation calculation unit 103 calculates the variance of the frequency spectrum intensity of the environmental sound.

In step SB2, the determination unit 104 compares the variance of the frequency spectrum intensity with the threshold (TH2). If, for example, the variance is less than the threshold TH2, 1 may be output as a comparison result. If the variance is equal to or more than the threshold TH2, 0 may be output as a comparison result.

In step SB3, the frequency variation calculation unit 103 calculates the center of gravity of the frequency spectrum intensity of the environmental sound.

In step SB4, the determination unit 104 compares the center of gravity of the frequency spectrum intensity with a threshold (TH3 for the sake of descriptive convenience). If, for example, the center of gravity is less than the threshold TH3, 1 may be output as a comparison result. If the center of gravity is equal to or more than the threshold TH3, 0 may be output as a comparison result.

Note that in steps SB2 and SB4, a comparison result may be information indicating whether the value of variance or the center of gravity of the frequency spectrum intensity falls within a predetermined range (the first threshold or more and the second threshold or less).

In step SB5, the determination unit 104 performs a logical operation of the three comparison results (binary values of 0 or 1) obtained by determination in steps SA3, SB2, and SB4. For example, the determination unit 104 calculates the logical product of the three comparison results as a logical operation result.

In step SB6, the determination unit 104 may compare the logical operation result with the threshold to determine whether the environmental sound includes an operating sound. If, for example, the logical operation result is larger than the threshold, since the three comparison results each can be regarded to satisfy the corresponding condition, the determination unit 104 may determine that the environmental sound includes an operating sound.

FIG. 7 shows an example of using three comparison results for determination processing for an operating sound. However, this is not exhaustive, and a logical operation may be performed by using four or more comparison results. For example, the comparison results obtained by comparing the variance of a power spectrum, the variance of a logarithmic power spectrum, and a partial autocorrelation coefficient may be added as elements for the above logical operation. In addition, referring to FIG. 7, the three representations calculated in steps SA2, SB1, and SB3 are individually compared with the thresholds in steps SA3, SB2, and SB4. However, this is not exhaustive. For example, the three representations may be linearly combined upon setting predetermined coefficients (weights) (weighted and summed), and the linearly combined value may be compared with a predetermined threshold. If the linearly combined value is larger than the threshold, the determination unit 104 may determine that the environmental sound includes an operating sound.

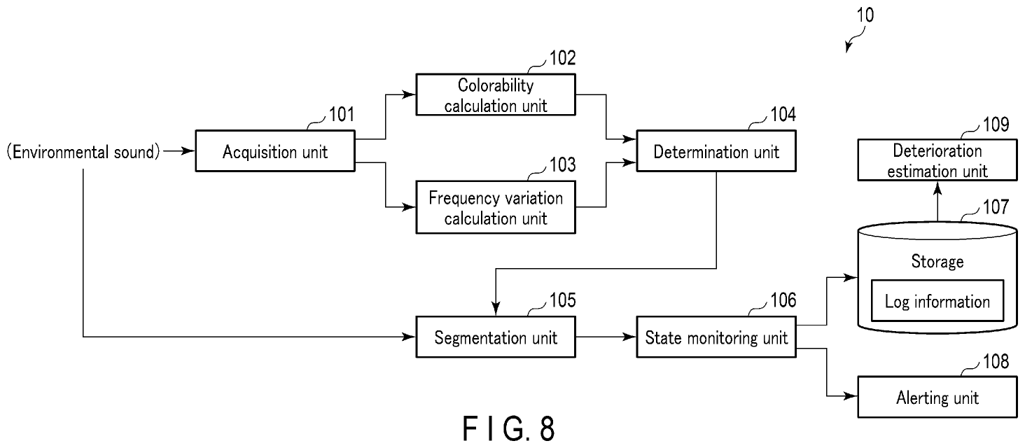

The second modification of the signal processing apparatus 10 according to the first embodiment will be described next with reference to the block diagram of FIG. 8.

The signal processing apparatus 10 shown in FIG. 8 includes a deterioration estimation unit 109 in addition to the components shown in FIG. 5.

The deterioration estimation unit 109 acquires log information (the time, anomaly score, and determination result about normal/anomaly) and estimates the deterioration state of the observation target based on the log information. For example, as disclosed in Jpn. Pat. Appln. KOKAI Publication No. 2021-135780, a deterioration curve is obtained from the anomaly score calculated by using deep neural network such as an auto-encoder and the corresponding time. A deterioration degree is then estimated from the difference from a deterioration curve based on an abrupt increase in anomaly score and a known standard operating time, thereby estimating a remaining life. Assume that an observation target is a motor. In this case, if the intensity of a high-frequency component of the operating sound of the motor in a partial environmental sound in which no anomaly has occurred gradually increases along the operating time, the anomaly score gradually increases, and it can be estimated that the motor begins to deteriorate.

As described above, referring to log information based on a partial environmental sound including the operating sound of an observation target and status information makes it possible to estimate how the operating sound changes and hence to estimate a deterioration in the observation target.

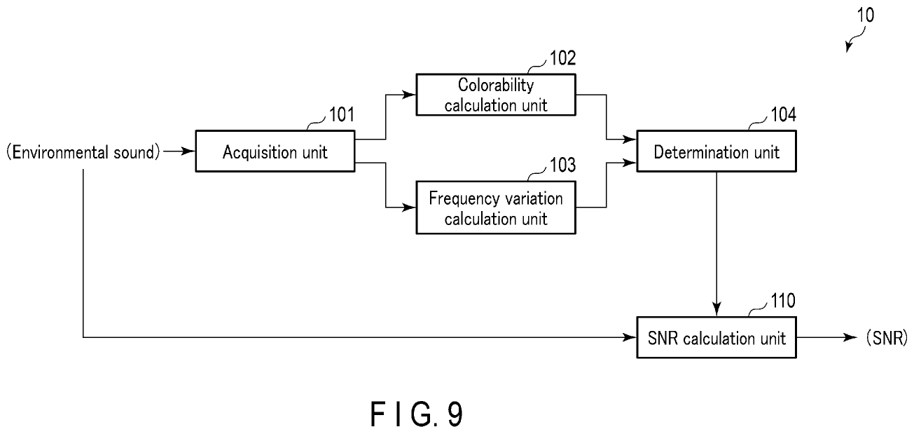

The third modification of the signal processing apparatus 10 according to the first embodiment will be described next with reference to the block diagram of FIG. 9.

The signal processing apparatus 10 shown in FIG. 9 includes an SNR (Signal to Noise Ratio) calculation unit 110 in addition to the components shown in FIG. 1.

The SNR calculation unit 110 receives an environmental sound from outside and a determination result from the determination unit 104 and calculates an SNR. This makes it possible to calculate the ratio of the operating sound of the observation target to the environmental sound. Assume that an observation target has failed and produced a large anomaly sound. In this case, since it can be determined that the operating sound is larger than that when the observation target has not failed, the large sound can be used as an index for anomaly determination.

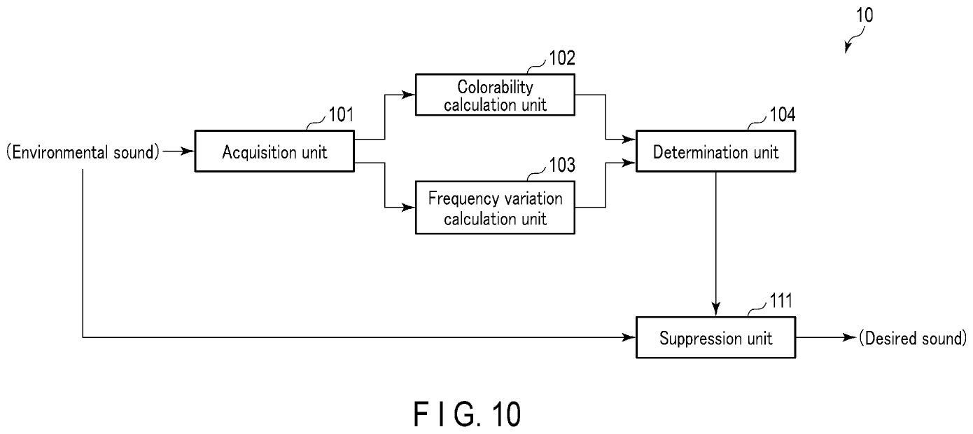

The fourth modification of the signal processing apparatus 10 according to the first embodiment will be described next with reference to the block diagram of FIG. 10.

The signal processing apparatus 10 shown in FIG. 10 includes a suppression unit 111 in addition to the components shown in FIG. 1.

The suppression unit 111 receives an environmental sound from outside and a determination result from the determination unit 104, suppresses the environmental sound except for the operating sound of the observation target, and extracts the operating sound of the observation target as a desired sound. Alternatively, the suppression unit 111 may suppress a desired sound and extract a background sound obtained by subtracting the desired sound from the environmental sound. For example, the suppression unit 111 performs short-time Fourier transform of an environmental sound signal, then calculates a suppression gain by a spectrum subtraction method, Wiener filter method, maximum likelihood estimation method, or the like using the component of the operating sound based on the determination result, and extracts a desired sound by multiplying the environmental sound signal by the suppression gain and performs inverse Fourier transform of the product.

Although not shown, the state monitoring unit 106 shown in FIG. 5 may execute similar state monitoring based on the desired sound output from the suppression unit 111 instead of the partial environmental sound.

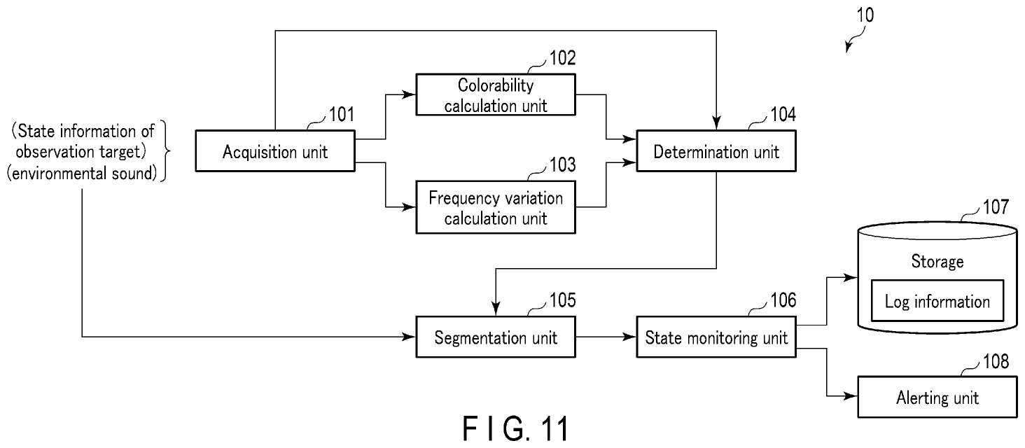

The fifth modification of the signal processing apparatus 10 according to the first embodiment will be described with reference to the block diagram of FIG. 11.

The signal processing apparatus 10 shown in FIG. 11 has the same arrangement as that shown in FIG. 5 but differs from it in that the acquisition unit 101 further acquires the state information of an observation target.

The state information of an observation target includes, for example, the ON/OFF information of the operation of the observation target, stage information indicating the intensity or level of the operation, and the position information of the observation target. If, for example, the observation target is a motor, the ON/OFF information indicates whether the motor is driven or stopped, and the stage information indicates the number of rotations or rotational frequency of the motor. The position information is information indicating, to the means for acquiring the environmental sound, the specific position of the observation target.

Acquiring the state information of an observation target in this manner may make the determination unit 104 execute determination processing for only an environmental sound when the observation target is operating. This improves the accuracy of segmentation processing by the segmentation unit 105.

In addition, based on the operation information of an observation target, the threshold for determination by the determination unit 104 can be changed. For example, in the case of operation information indicating that the observation target is operating (on), since a specific frequency may increase, the threshold for colorability determination by the determination unit 104 is increased. In contrast to this, in the case of operation information indicating that the observation target is stopped (off), the threshold for colorability determination by the determination unit 104 may be reduced.

According to the first embodiment described above, the colorability of an environmental sound and variation in frequency spectrum intensity are calculated, and threshold determination is performed to determine by threshold determination whether the environmental sound includes the operating sound of the observation target. Accordingly, even if, for example, an operating sound similar in characteristic to ambient noise is to be extracted as a desired sound from an environmental sound, since noise has the characteristic of having high whiteness, evaluating colorability and variation in frequency spectrum intensity can improve the accuracy of the extraction of the operating sound of the observation target. This makes it possible to implement accurate determination with a small processing amount and mount the apparatus on, for example, a small edge device with limited calculation resources.

### Second Embodiment

It is assumed in the second embodiment that a trained model is used for state monitoring, and a trained model is generated and updated by transmitting a partial environmental sound to a server.

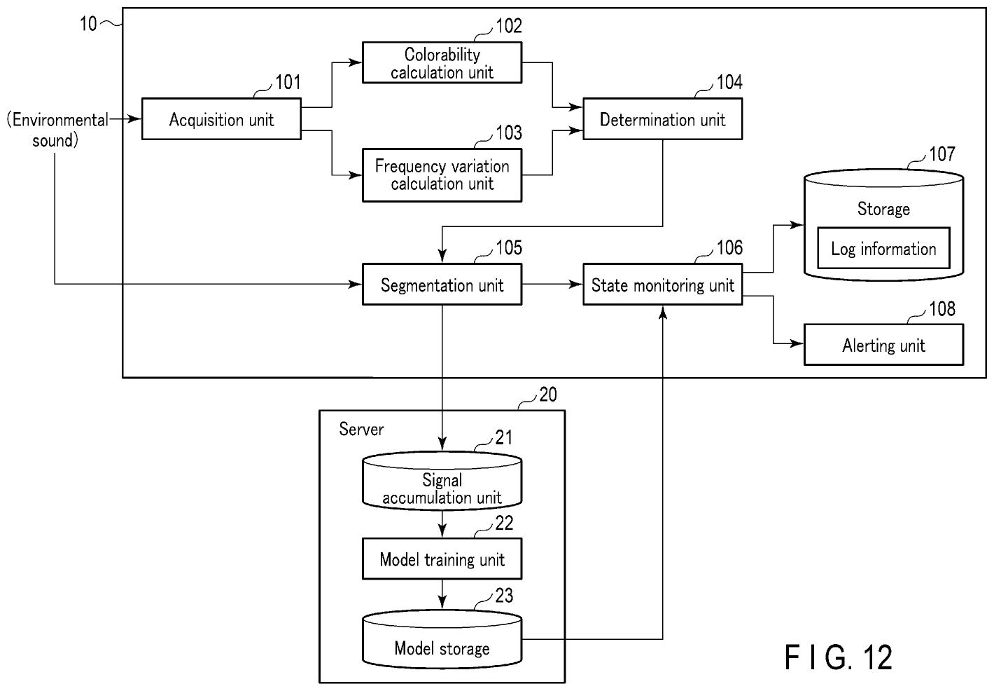

A signal processing system according to the second embodiment will be described with reference to the block diagram of FIG. 12.

The signal processing system shown in FIG. 12 includes a signal processing apparatus 10 and a server 20. The signal processing apparatus 10 is similar to the signal processing apparatus 10 shown in FIG. 5. The server 20 includes a signal accumulation unit 21, a model training unit 22, and a model storage 23.

The signal accumulation unit 21 receives and stores a partial environmental sound from a segmentation unit 105 of the signal processing apparatus 10.

The model training unit 22 receives a partial environmental sound from the signal accumulation unit 21 and trains a machine learning model designed for anomaly detection as a task upon inputting the partial environmental sound, thereby generating a trained model. The machine learning model executes unsupervised learning so as to identify normal data and anomaly data by using, for example, a neural network such as an auto-encoder or variational auto-encoder. Note that a training technique for a machine learning model can be implemented within the framework of general machine learning designed for anomaly detection as a task, and hence a description of the technique will be omitted.

Note that a support vector machine, logistic regression, or the like may be used instead of a neural network.

The model storage 23 receives and stores a trained model from the model training unit 22.

A state monitoring unit 106 of the signal processing apparatus 10 receives a trained model from the model storage 23 and holds the generated trained model if the model is acquired for the first time. If the trained model is acquired for the second or subsequent time, the state monitoring unit 106 updates the model into a newly acquired trained model.

According to the second embodiment described above, the server trains a machine learning model by using a partial environmental sound including the operating sound of an observation target and generates a trained model. The state monitoring unit determines the state of the observation target by using the generated or updated trained model, that is, monitors the observation target. Accordingly, even if the environmental sound has changed, it is possible to generate a suitable trained model from the partial environmental sound and maintain and improve the monitoring accuracy of the observation target.

### Third Embodiment

The third embodiment will exemplify the use of a signal processing apparatus 10 for elevator monitoring as a specific example of use.

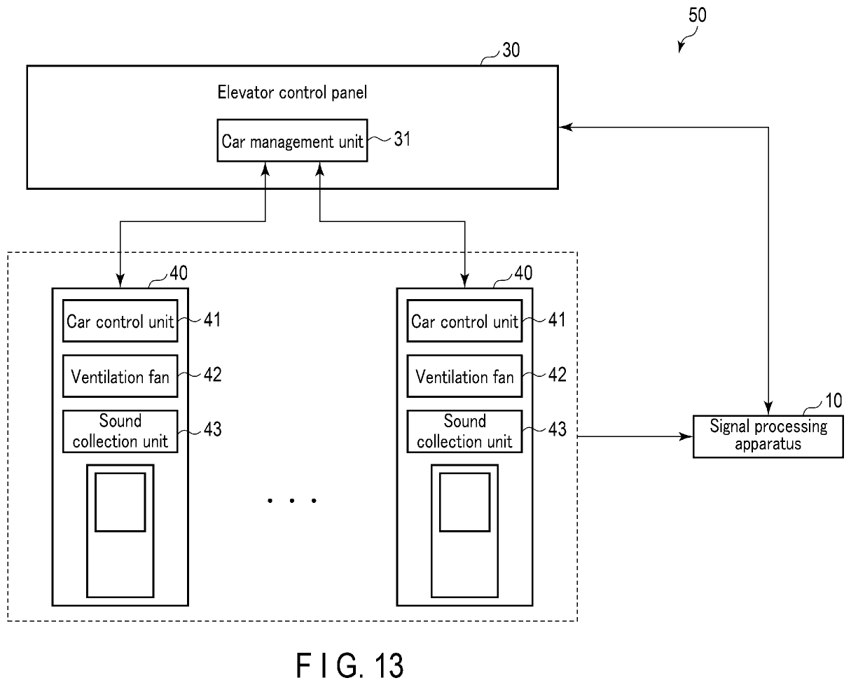

An elevator monitoring apparatus including the signal processing apparatus 10 according to the third embodiment will be described with reference to the conceptual view of FIG. 13.

An elevator monitoring apparatus 50 shown in FIG. 13 includes the signal processing apparatus 10, an elevator control panel 30, and one or more elevator cars 40.

The elevator control panel 30 includes a car management unit 31.

The car management unit 31 controls the movement of the elevator car 40 between floors, the opening/closing of the door, the state of the ventilation fan, and the like.

A car control unit 41, a ventilation fan 42, and a sound collection unit 43 are arranged in the elevator car 40.

The car control unit 41 receives an instruction from the elevator control panel 30 and controls the elevator car 40 in accordance with the instruction. More specifically, the car control unit 41 controls the opening/closing of the door of the elevator car 40, the traveling direction of the elevator car 40, the destination floor (hall), the speed, the ON/OFF of the ventilation fan, and the like.

The ventilation fan 42 is installed to exhaust air inside the elevator car 40 to the outside.

The sound collection unit 43 is, for example, a microphone installed in the elevator car 40 and collects an environmental sound around the elevator car 40. For example, the environmental sound collected by the sound collection unit 43 includes the operating sound of the elevator car 40 during an elevating operation, the operating sound of the ventilation fan 42, the operating sound associated with the opening/closing of the door, people's speaking voices in the car, sounds collected when the door is open, such as people's speaking voices on the waiting area, the music broadcasted in the building, and noise from the surrounding environment, noise from the surrounding environment due to the construction of a neighboring building or the like, and the operating sound of an adjacent elevator. In addition to these sounds, the sound collection unit 43 collects the sounds made when people ride in and off the elevator car 40, the stepping sounds made when people move inside the car, the sounds made when goods are transported with a shopping cart or people ride in and off the car, the sounds made by the vibration of the car, including the sounds when people or goods collide with the door at the time of opening/closing of the door, and the like. If one microphone is to be used, the sound collection unit 43 is preferably placed on the door side of the outside-car ceiling portion of the elevator car 40. Note that the sound collection unit 43 may be constituted by a plurality of microphones. In this case, the microphones are preferably placed on the door side of the outside-car ceiling portion of the elevator car 40 and the door side near the inside-car ceiling. Placing the microphones in this manner makes it possible to accurately collect the operating sound of the elevator car 40 as an observation target (the sound made when the car moves up and down and the sound made when the door opens and closes at the time of stopping of the car).

In the elevator monitoring apparatus 50, the elevator car 40 and the ventilation fan 42 are set as observation targets. In this case, for elevator maintenance, when the car moves up and down, the mechanism for moving the car up and down is set as an observation target, whereas when the car is at rest, the mechanism for opening/closing the door is set as an observation target. In addition, the ventilation fan mechanism that operates when the car moves up and down or is at rest is set as an observation target. Note that observation targets may include sound sources existing in the operating environment of the elevator such as a loudspeaker that outputs an in-house broadcast inside the door or the elevator car 40 as well as the operating sounds of the elevator car 40 and the ventilation fan 42.

The signal processing apparatus 10 receives the state information of the observation targets from the elevator control panel 30 and the environmental sound acquired by the sound collection unit 43 and determines whether the environmental sound includes the operating sounds of the observation targets, that is, the operating sound of the elevator car 40 and the operating sound of the ventilation fan 42. More specifically, the signal processing apparatus 10 obtains information indicating whether the car 40 moves up and down or is at rest from the car control unit 41 and determines whether the environmental sound includes the operating sound of the car if it moves up and down or whether the environmental sound includes the operating sound of the door when it opens/closes and the operating sound of the ventilation fan if the car is at rest. As described above, the environmental sound includes various types of sounds (disturbances) other than a desired operating sound. The operation of the signal processing apparatus 10 is similar to that in the above embodiment. The operating sound of the car and the sound of the ventilation fan have characteristics of having large colorability and small frequency variation. In a closed space such as an elevator, a sound resonates and hence increases in diffusivity, resulting in an increase in frequency variation as compared with a sound having a specific frequency. A human voice has moderate colorability and moderate frequency variation. Steady noise has small colorability and large frequency variation. Noise having a specific frequency has large colorability and very small frequency variation. Noise like music has small colorability and moderate frequency variation. Noise due to the vibration of the car or noise with attacking property has large colorability and large frequency variation (that is, the noise is referred to as color noise). Using both colorability and frequency variation is effective in determining, from the characteristics of these sounds, whether the environmental sound includes the operating sound of an observation target. That is, this is effective in identifying the sound due to vibration and the mechanical sound of the observation target. Note that the signal processing apparatus 10 included in the elevator monitoring apparatus 50 may be installed in the elevator car 40 or incorporated in the elevator control panel 30. Alternatively, if the environmental sound acquired by the sound collection unit 43 can be transmitted wirelessly, the signal processing apparatus 10 may be included in an external server.

As in the first embodiment, for a reduction in processing amount, calculation processing for colorability and frequency variation may be executed after the environmental sound acquired by the sound collection unit 43 is down-sampled from 48 kHz to 8 kHz.

According to the third embodiment described above, it is determined whether the environmental sound collected by the sound collection unit installed in the elevator car includes the operating sounds of the elevator car and the ventilation fan which are observation targets. This makes it possible to properly extract the operating sounds of the observation targets, that is, the operating sound of the elevator car and the operating sound of the ventilation fan, from the environmental sound and to easily determine whether there is an anomaly in the operation, thereby implementing efficient elevator monitoring.

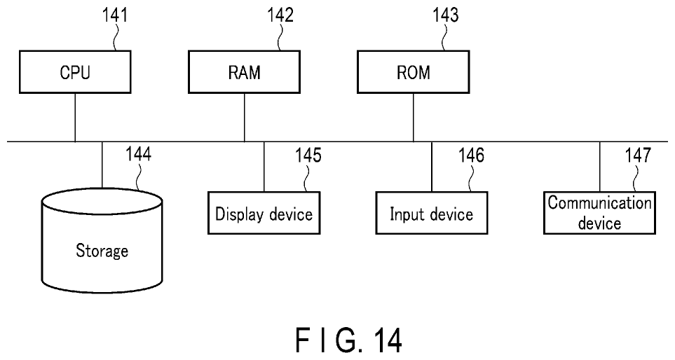

The block diagram of FIG. 14 shows an example of the hardware arrangement of the signal processing apparatus 10 according to the above embodiment.

The signal processing apparatus 10 includes a CPU (Central Processing Unit) 141, a RAM (Random Access Memory) 142, a ROM (Read Only Memory) 143, a storage 144, a display device 145, an input device 146, and a communication device 147. These components are connected to each other via a bus.

The CPU 141 is a processor that executes arithmetic calculation processing, control processing, and the like in accordance with programs. The CPU 141 uses a predetermined area of the RAM 142 as a work area and executes processing in each unit of the signal processing apparatus 10 described above in cooperation with programs stored in the ROM 143, the storage 144, and the like.

The RAM 142 is a memory such as an SDRAM (Synchronous Dynamic Random Access Memory). The RAM 142 functions as a work area of the CPU 141. The ROM 143 is a memory for storing programs and various pieces of information such that they cannot be rewritten.

The storage 144 is a device for writing data in and reading out data from a magnetic recording medium such as an HDD (Hard Disc Drive), a semiconductor storage medium such as a flash memory, a magnetically recordable storage medium such as an HDD, an optically recordable storage medium, or the like. The storage 144 writes data in and reads out data from the storage medium under the control of the CPU 141.

The display 145 is a display device such as an LCD (Liquid Crystal Display). The display 145 displays various information based on display signals from the CPU 141.

The input device 146 is an input device such as a mouse or a keyboard. The input device 146 accepts information input by the user as an instruction signal and outputs the instruction signal to the CPU 141.

The communication device 147 communicates with an external apparatus across a network under the control of the CPU 141.

Instructions shown in the procedures explained in the above-described embodiments can be executed based on a program as software. When a versatile computer system prestores this program and loads the program, the same effects as those of the control operation of the above-described signal processing apparatus can be obtained. The instructions described in the above embodiments are recorded as a computer-executable program in a magnetic disk (e.g., a flexible disk or a hard disk), an optical disk (e.g., a CD-ROM, a CD-R, a CD-RW, a DVD-ROM, a DVD±R, a DVD±RW, or a Blu-ray® Disc), a semiconductor memory, or a similar recording medium. The storage format can be any form as long as the recording medium is readable by a computer or an embedded system. A computer can implement the same operation as that of the control of the signal processing apparatus of the above-described embodiment by loading the program from this recording medium and, based on the program, causing a CPU to execute instructions described in the program. When acquiring or loading the program, the computer can of course acquire or load the program across a network.

Also, based on the instructions of the program installed in a computer or an embedded system from the recording medium, an OS (Operating System) or database management software operating on the computer or a MW (MiddleWare) such as a network can execute a part of each processing in order to implement this embodiment.

Furthermore, the recording medium of this embodiment is not limited to a medium independent of a computer or an embedded system, but includes a recording medium that downloads a program transmitted across, e.g., a LAN or the Internet and stores or temporarily stores the program.

Also, the recording medium is not limited to one medium, and the recording medium of this embodiment includes a case in which the processes of this embodiment are executed from a plurality of media. The configuration of each medium can be any configuration.

Note that the computer or the embedded system according to this embodiment executes each processing of this embodiment based on the program stored in the recording medium, and can be either a single device such as a personal computer or a microcomputer, or a system in which a plurality of devices are connected across a network.

Note also that the computer according to this embodiment is not limited to a personal computer but includes an arithmetic processing device included in an information processing apparatus, a microcomputer, and the like. That is, the “computer” according to this embodiment is a general term of apparatuses and devices capable of implementing the functions of this embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A signal processing apparatus comprising processing circuitry configured to:
acquire an environmental sound in an environment where an operating sound of an observation target can be collected;
calculate colorability and variation in frequency spectrum intensity concerning the environmental sound; and
determine whether or not the environmental sound includes the operating sound by comparing the colorability and a degree of the variation with thresholds.

2. The apparatus according to claim 1, wherein the processing circuitry determines that the environmental sound includes the operating sound if the environmental sound has the colorability and the variation is small.

3. The apparatus according to claim 2, wherein the processing circuitry is further configured to segment a partial environmental sound that is determined by the processing circuitry to include the operating sound.

4. The apparatus according to claim 3, wherein the processing circuitry is further configured to monitor a state of the observation target based on the partial environmental sound.

5. The apparatus according to claim 4, wherein the processing circuitry determines from the operating sound included in the partial environmental sound whether the observation target is normal or anomaly.

6. The apparatus according to claim 1, wherein the processing circuitry is further configured to calculate a signal to noise ratio of a partial environmental sound determined by the processing circuitry to include the operating sound.

7. The apparatus according to claim 1, wherein the processing circuitry is further configured to generate a desired sound by suppressing a partial environmental sound determined by the processing circuitry to include the operating sound except for the operating sound.

8. The apparatus according to claim 7, wherein the processing circuitry is further configured to monitor a state of the observation target based on the desired sound.

9. The apparatus according to claim 8, wherein the processing circuitry determines based on the desired sound whether the observation target is normal or anomaly.

10. The apparatus according to claim 1, wherein the processing circuitry calculates the colorability by calculating an autocorrelation coefficient of the environmental sound.

11. The apparatus according to claim 1, wherein wherein the processing circuitry calculates the variation from at least one of a variance and a center of gravity of a frequency spectrum intensity of the environmental sound.

12. The apparatus according to claim 1, wherein the processing circuitry determines, based on at least one of ON/OFF information of an operation of the observation target and position information of the observation target during acquisition of the environmental sound, whether or not the environmental sound includes the operating sound.

13. A signal processing method comprising:
acquiring an environmental sound in an environment where an operating sound of an observation target can be collected;
calculating colorability and variation in frequency spectrum intensity concerning the environmental sound; and
determining whether or not the environmental sound includes the operating sound by comparing the colorability and a degree of the variation with thresholds.

14. An elevator monitoring apparatus comprising:
one or more sound collection units installed in an elevator car and configured to acquire an environmental sound in an environment where an operating sound of an observation target can be collected; and
processing circuitry configured to:
calculate colorability and variation in frequency spectrum intensity concerning the environmental sound; and
compare the colorability and a degree of the variation with thresholds and determine whether the environmental sound includes the operating sound.
